(19) United States
(12) Patent Application Publication
(10) Pub. No.: US 2017/0243528 A1
(43) Pub. Date: Aug. 24, 2017

(54) DISPLAY DEVICE REDUCING SOURCE DRIVER CHANNELS AND METHOD FOR DRIVING THE SAME

(71) Applicant: WUHAN CHINA STAR OPTOELECTRONICS TECHNOLOGY CO., LTD., Wuhan, Hubei (CN)

(72) Inventors: Feilin JI, Wuhan, Hubei (CN); Wei CHEN, Wuhan, Hubei (CN); Xiaoping TAN, Wuhan, Hubei (CN)

(21) Appl. No.: 14/906,779

(22) PCT Filed: Jan. 13, 2016
(86) PCT No.: PCT/CN2016/070811

§ 371 Date: Jan. 21, 2016

(30) Foreign Application Priority Data
Dec. 15, 2015 (CN) 201510938692.9

(51) Int. Cl. G09G 3/20; G09G 3/3291; G09G 3/36

(52) U.S. Cl. CPC G09G 3/2003; G09G 3/3607; G09G 3/3614; G09G 3/3688; G09G 3/3291; G09G 2300/0452; G09G 2300/0823; G09G 2330/021

(57) ABSTRACT

A display device includes a first switching unit conducting data signals of a first polarity to the first sub-pixel upon first enabling signal, a second switching unit conducting data signals of first polarity to the sixth sub-pixel upon second enabling signal, a third switching unit conducting data signals of first polarity to the seventh sub-pixel upon third enabling signal, a fourth switching unit conducting data signals of first polarity to the fourth sub-pixel upon fourth enabling signal, a fifth switching unit conducting data signals of second polarity to the fifth sub-pixel upon first enabling signal, a sixth switching unit conducting data signals of second polarity to the second sub-pixel upon second enabling signal, a seventh switching unit conducting data signals of second polarity to the third sub-pixel upon third enabling signal, and an eighth switching unit conducting data signals of second polarity to eighth sub-pixel upon fourth enabling signal.

### BACKGROUND OF THE INVENTION

1. Field of the Invention

The present invention relates to a display device, and more specifically to a display device that reduces the number of source driver channels and a method for driving the display device.

2. Description of the Prior Art

Display device adopting conventional liquid crystal display (LCD) panels integrate red (R) sub-pixels, green (G) sub-pixels and blue (B) sub-pixels into a pixel unit. A color image is displayed through controlling the grey-scale value of each sub-pixel and mixing the sub-pixels into the needed colors. As information technology advances, LCD panels are expected to meet more needs, including high transmittance rate, low power consumption, and better image quality. The conventional RGB LCD panel has lower transmittance rate and mixing efficiency, thus its power consumption is higher.

Therefore, another approach of the conventional technology is to compose a pixel unit with a R sub-pixel, G sub-pixel, B sub-pixel and white (W) sub-pixel. Comparing with a RGB display device, a RGBW display device, with each pixel unit composed of four sub-pixels, has higher pixel resolution and transmittance rate, and more color variety, resulting to better display quality.

A RGB display device of 1080×1920 resolution has 3240 (1080×3)sub-pixels in each row, so a source driver needs 3240 channels to transmit signals to 3240 sub-pixels. Although RGBW display device can make use of the sub-pixel sharing technology to reduce the channels the source driver needs to 2160, the design of the display device can be more flexible if the number of channels can be further decreased.

Therefore, the industry can work on how to produce a display device whose source driver requires fewer channels.

### SUMMARY OF THE INVENTION

An object of the present invention is to provide a display device that reduces the source driver's channels and a method of driving the same, so to solve the existing technical problem.

According to the present invention, a display device comprises: a source driver for outputting data signals; a first pixel unit, comprising a first sub-pixel, a second sub-pixel, a third sub-pixel and a fourth sub-pixel, lining up along a row; a second pixel unit, comprising a fifth sub-pixel, a sixth sub-pixel, a seventh sub-pixel and an eighth sub-pixel, lining up along the row; a first switching unit, electrically connecting the source driver and the first sub-pixel, for conducting data signals of a first polarity to the first sub-pixel when receiving a first enabling signal; a second switching unit, electrically connecting the source driver and the sixth sub-pixel, for conducting data signals of the first polarity to the sixth sub-pixel when receiving a second enabling signal; a third switching unit, electrically connecting the source driver and the seventh sub-pixel, for conducting data signals of the first polarity to the seventh sub-pixel when receiving a third enabling signal; a fourth switching unit, electrically connecting the source driver and the fourth sub-pixel, for conducting data signals of the first polarity to the fourth sub-pixel when receiving a fourth enabling signal; a fifth switching unit, electrically connecting the source driver and the fifth sub-pixel, for conducting data signals of a second polarity to the fifth sub-pixel when receiving the first enabling signal; a sixth switching unit, electrically connecting the source driver and the second sub-pixel, for conducting data signals of the second polarity to the second sub-pixel when receiving the second enabling signal; a seventh switching unit, electrically connecting the source driver and the third sub-pixel, for conducting data signals of the second polarity to the third sub-pixel when receiving the third enabling signal; and an eighth switching unit, electrically connecting the source driver and the eighth sub-pixel, for conducting data signals of the second polarity to the eighth sub-pixel when receiving the fourth enabling signal.

In one aspect of the present invention, the first sub-pixel and the fifth sub-pixel are red sub-pixels, the second sub-pixel and the sixth sub-pixel are green sub-pixels, the third sub-pixel and the seventh sub-pixel are blue sub-pixels, and the fourth sub-pixel and the eighth sub-pixel are white sub-pixels.

In another aspect of the present invention, the first polarity is opposite to the second polarity.

In still another aspect of the present invention, the polarity of the data signal of the first frame and that of the second frame outputted consecutively by the source driver are opposite to each other.

In yet another aspect of the present invention, the display device is a liquid crystal display (LCD) or an organic light-emitting diode (OLED) display.

According to the present invention, a method for driving a display device is proposed. The display device comprises: a source driver for, outputting data signals; a first pixel unit, comprising a first sub-pixel, a second sub-pixel, a third sub-pixel and a fourth sub-pixel, lining up along a row; a second pixel unit, comprising a fifth sub-pixel, a sixth sub-pixel, a seventh sub-pixel and an eighth sub-pixel, lining up along the row; a first switching unit, electrically connecting the source driver and the first sub-pixel; a second switching unit, electrically connecting the source driver and the sixth sub-pixel; a third switching unit, electrically connecting the source driver and the seventh sub-pixel; a fourth switching unit, electrically connecting the source driver and the fourth sub-pixel; a fifth switching unit, electrically connecting the source driver and the fifth sub-pixel; a sixth switching unit, electrically connecting the source driver and the second sub-pixel; a seventh switching unit, electrically connecting the source driver and the third sub-pixel; an eighth switching unit, electrically connecting the source driver and the eighth sub-pixel. The method comprises: when receiving a first enabling signal, the first switching unit conducting data signals of a first polarity to the first sub-pixel, and the fifth switching unit conducting data signals of a second polarity to the fifth sub-pixel; when receiving a second enabling signal, the second switching unit conducting data signals of the first polarity to the sixth sub-pixel, and the sixth switching unit conducting data signals of the second polarity to the second sub-pixel; when receiving a third enabling signal, the third switching unit conducting data signals of the first polarity to the seventh sub-pixel, and the seventh switching unit conducting data signals of the second polarity to the third sub-pixel; when receiving a fourth enabling signal, the fourth switching unit conducting data signals of the first polarity to the fourth sub-pixel, and the eighth switching unit conducting data signals of the second polarity to the fourth sub-pixel.

In one aspect of the present invention, the first sub-pixel and the fifth sub-pixel are red sub-pixels, the second sub-pixel and the sixth sub-pixel are green sub-pixels, the third sub-pixel and the seventh sub-pixel are blue sub-pixels, and the fourth sub-pixel and the eighth sub-pixel are white sub-pixels.

In another aspect of the present invention, the first polarity is opposite to the second polarity.

In still another aspect of the present invention, the polarity of the data signal of the first frame and that of the second frame outputted consecutively by the source driver are opposite to each other.

In yet another aspect of the present invention, the display device is a liquid crystal display (LCD) or an organic light emitting diode (OLED) display.

In contrast to the prior art, the number of source driver channels of the display device and the method of driving the same of the present invention is only half of the RGB display device. The present invention reduces the number of source driver channels and buffer operation amplifiers of the source driver IC output terminal. Therefore it reduces the power consumption and size of the source driver IC and attains to beneficial effects of less source driver IC power consumption and cost.

These and other objectives of the present invention will become apparent to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display device according to a preferred embodiment of the present invention.

FIG. 2 is a schematic diagram of the display panel of the present invention.

FIG. 3 is a schematic diagram of the source driver, switching units and pixel units of the present invention.

FIG. 4 is a flow chart of the method for driving the display device of the present invention.

FIG. 5 is a timing chart of each enabling signal and scan signal when driving the device of the present invention.

### DETAILED DESCRIPTION OF PREFERRED EMBODIMENTS

The following description of each embodiment, with reference to the accompanying drawings, is used to exemplify specific embodiments which may be carried out in the present invention. Directional terms mentioned in the present invention, such as “top”, “bottom”, “front”, “back”, “left”, “right”, “inside”, “outside”, “side”, etc., are only used with reference to the orientation of the accompanying drawings. Therefore, the used directional terms are intended to illustrate, but not to limit, the present invention. In the drawings, units with similar structures are marked with the same labels.

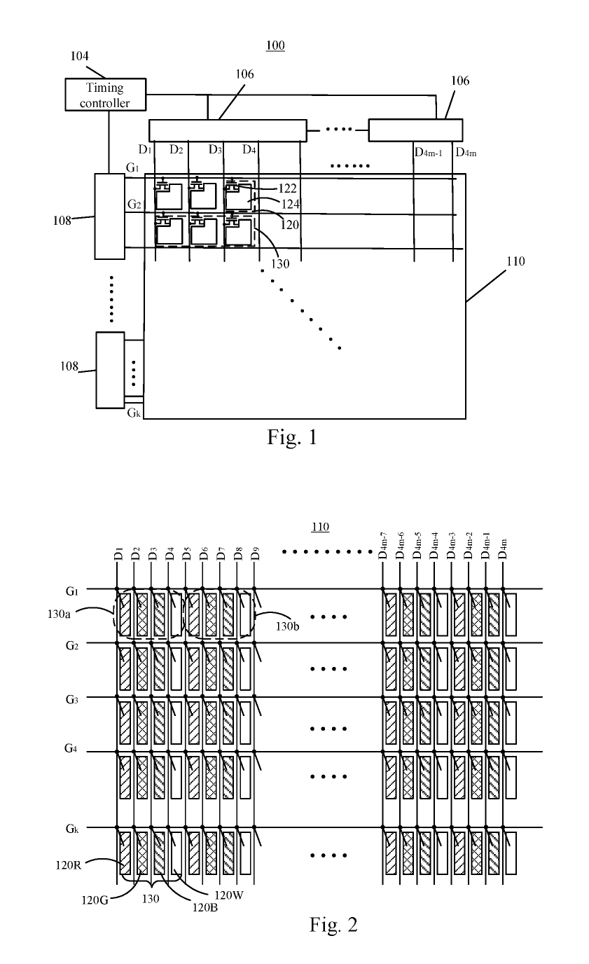

Please refer to FIG. 1. FIG. 1 is a schematic diagram of a display device 100 according to a preferred embodiment of the present invention. The display device 100 can be a LCD or organic light-emitting diode (OLED) display, and serves as the screen of personal computers or notebooks. The display device 100 comprises a timing controller 104, source driver 106, gate driver 108 and display panel 110. The display panel 110 comprises a plurality of scan lines G₁ to Gₖ, a plurality of data lines D_{1 to} D₄ₘ, and a plurality of pixel units 130. The plurality of pixel units 130 are arranged in an array, and each pixel unit 130 comprises at least four sub-pixel units 120—red, green, blue and white. The sub-pixel units 120 are disposed in the area where the plurality of scan lines G₁to Gₖ intersects with the plurality of data lines D₁to D₄ₘ. When vertical synchronization (VSYNC) signals produced by the timing controller 104 are sent to the gate driver 108, the gate driver 108 produces and sends scan pulses to the display panel 110 through scan lines G₁ to Gₖ. At the same time, the timing controller 104 sends horizontal synchronization (HSYNC) signals to source driver 106. The source driver 106 runs parallel output to send grey-scale voltage signals to the sub-pixel units 120 of the display panel 100 through data lines D₁ to D₄ₘ. Each sub-pixel unit 120 comprises a pixel electrode 124 and a thin-film transistor (TFT) 122. The gate, source and drain of the TFT 122 electrically connect the scan lines and data lines of corresponding sub-pixel units 120 and corresponding pixel electrodes 124 respectively. The gate driver 108 transmits scan pulses through scan lines G₁ to Gₖ, and the source driver 106 transmits data voltage signals through data lines D₁ to D₄ₘ.

Please refer to FIG. 2. FIG. 2 is a schematic diagram of the display panel 110 of the present invention. Each pixel unit 130 is composed of a red sub-pixel 120R, green sub-pixel 120G, blue sub-pixel 120B and white sub-pixel 120W that are lined up in rows. For the benefit of explaining the present embodiment, two neighboring pixel units 130 in the same row are referred to as a first pixel unit 130a and a second pixel unit 130b, which are disposed alternately. When the first pixel unit 130a receives a first image, the source driver 106 provides data signals that show a first polarity through data lines to the pixel unit 130a. When the second pixel unit 130b receives a first image, the source driver 106 provides data signals that show a second polarity through data lines to the pixel unit 130b. When the first pixel unit 130a receives a second image (i.e. the image that follows the first), the source driver 106 provides data signals that show the second polarity through data lines to the pixel unit 130a. When the second pixel unit 130b receives the second image, the source driver 106 provides data signals that show the first polarity through data lines to the pixel unit 130b.

The first polarity is opposite to the second polarity. More specifically, when the first polarity is positive, the second polarity is negative. When the source driver 106 provides data signals of positive polarity to the pixel unit 130, the difference between the data signal and the common electrode voltage is positive. When the source driver 106 provides data signals of negative polarity to the pixel unit 130, the difference between the data signal and the common electrode voltage is negative. The first pixel unit 130a and the second pixel unit 130b show images according to the data signals alternating between the first polarity and second polarity along with the change of images.

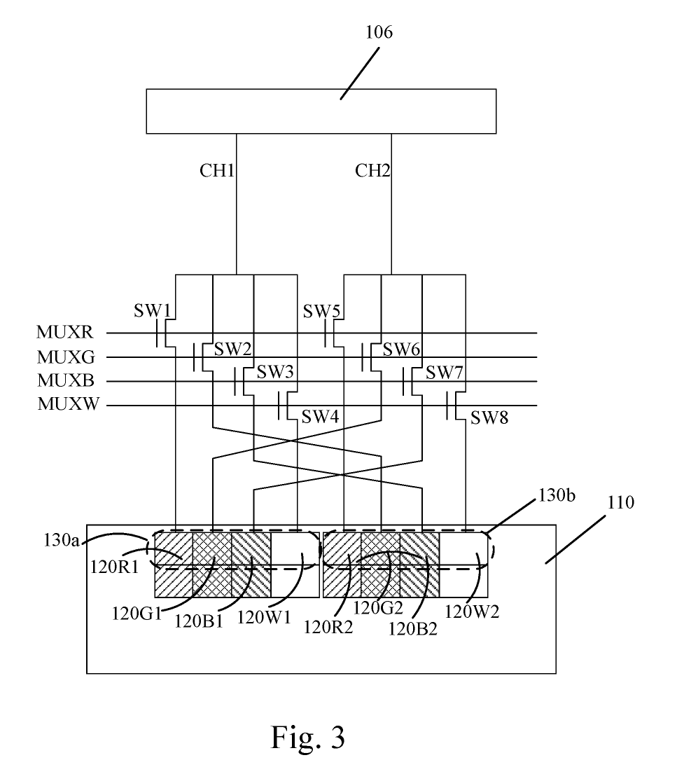

Please refer to FIG. 3. FIG. 3 is a schematic diagram of the source driver, switching units and pixel units of the present invention. A first switching unit SW1 electrically connects the source driver 106 and a red sub-pixel 120R1 of the first pixel unit 130a. A second switching unit SW2 electrically connects the source driver 106 and a green sub-pixel 120G2 of the second pixel unit 130b. A third switching unit SW3 electrically connects the source driver 106 and a blue sub-pixel 120B2 of the second pixel unit 130b. A fourth switching unit SW4 electrically connects the source driver 106 and a white sub-pixel 120W1 of the first pixel unit 130a. A fifth switching unit SW5 electrically connects the source driver 106 and a red sub-pixel 120R2 of the second pixel unit 130b. A sixth switching unit SW6 electrically connects the source driver 106 and a green sub-pixel 102G1 of the first pixel unit 130a. A seventh switching unit SW7 electrically connects the source driver 106 and a blue sub-pixel 120B1 of the first pixel unit 130a. An eighth switching unit SW8 electrically connects the source driver 106 and a white sub-pixel 120W2 of the second pixel unit 130b.

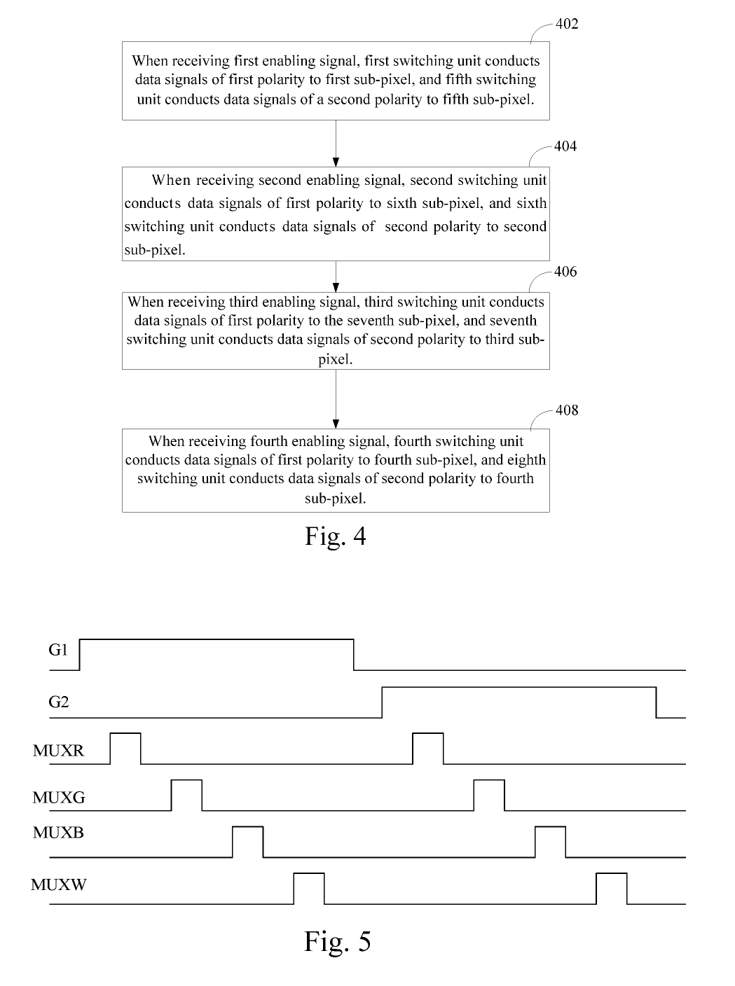

Please refer to FIG. 3, FIG. 4 and FIG. 5. FIG. 4 is a flow chart of the method for driving the display device of the present invention. FIG. 5 is a timing chart of each enabling signal and scan signal when driving the device of the present invention. The method for driving the display device of the present invention comprises:

Step 402: When receiving the first enabling signal MUXR, the first switching unit SW1 conducts a data signal R(2n) of the first polarity sent from a first channel CH1 of the source driver 106 to the red sub-pixel 120R1 of the first pixel unit 130a. The fifth switching unit SW5 conducts a data signal R(2n+1) of the second polarity sent from a second channel CH2 of the source driver 106 to the red sub-pixel 120R2

Step 404: When receiving a second enabling signal MUXG, the second switching unit SW2 conducts a data signal G(2n+1) of the first polarity sent from the first channel CH1 to the green sub-pixel 120G2 of the second pixel unit 130b. The sixth switching unit SW6 conducts a data signal G(2n) of the second polarity sent from the second channel CH2 to the green sub-pixel 120G1 of the first pixel unit 130a.

Step 406: When receiving a third enabling signal MUXB, the third switching unit SW3 conducts a data signal B(2n+1) of the first polarity sent from the first channel CH1 to the blue sub-pixel 120B2 of the second pixel unit 130b. The seventh switching unit SW7 conducts a data signal B(2n) of a second polarity sent from the second channel CH2 to the blue sub-pixel 120B1 of the first pixel unit 130a.

Step 408: When receiving the fourth enabling signal MUXW, the fourth switching unit SW4 conducts a data signal W(2n) of the first polarity sent from the first channel CH1 to the white sub-pixel 120W1 of the first pixel unit 130a. The eighth switching unit SW8 conducts a data signal W(2n+1) of a second polarity to the white sub-pixel 120W2 of the second pixel unit 130b.

Please note that in the present embodiment, the data signals of the red sub-pixel 120R1 and the white sub-pixel 120W1 of the first pixel unit 130a are sent from the first channel CH1, and that of the red sub-pixel 120R2 and white sub-pixel 120W2 of the second pixel unit 130b are sent from the second channel CH2. The data signals of the green sub-pixel 120G1 and the blue sub-pixel 120B1 of the first pixel unit 130a are sent from the second channel CH2, and that of the green sub-pixel 120G2 and blue sub-pixel 120B2 of the second pixel unit 130b are sent from the first channel CH1.

Since each channel of the source driver 106 connects to a 1:4 multiplexer, each pixel unit (comprising R, G, B, W four sub-pixel units) only connects one of the channels of the source driver 106. It can greatly reduce the number of channels that the source driver needs.

The number of source driver channels of the display device and the method of driving the same of the present invention is only half of the RGB display device. The present invention reduces the number of source driver channels and buffer operation amplifiers of the source driver IC output terminal. Therefore it reduces the power consumption and size of the source driver IC and attains to beneficial effects of less source driver IC power consumption and cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display, comprising:
a source driver for outputting data signals;
a first pixel unit, comprising a first sub-pixel, a second sub-pixel, a third sub-pixel and a fourth sub-pixel, lining up along a row;
a second pixel unit, comprising a fifth sub-pixel, a sixth sub-pixel, a seventh sub-pixel and an eighth sub-pixel, lining up along the row;
a first switching unit, electrically connecting the source driver and the first sub-pixel, for conducting data signals of a first polarity to the first sub-pixel when receiving a first enabling signal;
a second switching unit, electrically connecting the source driver and the sixth sub-pixel, for conducting data signals of the first polarity to the sixth sub-pixel when receiving a second enabling signal;
a third switching unit, electrically connecting the source driver and the seventh sub-pixel, for conducting data signals of the first polarity to the seventh sub-pixel when receiving a third enabling signal;
a fourth switching unit, electrically connecting the source driver and the fourth sub-pixel, for conducting data signals of the first polarity to the fourth sub-pixel when receiving a fourth enabling signal;
a fifth switching unit, electrically connecting the source driver and the fifth sub-pixel, for conducting data signals of a second polarity to the fifth sub-pixel when receiving the first enabling signal;
a sixth switching unit, electrically connecting the source driver and the second sub-pixel, for conducting data signals of the second polarity to the second sub-pixel when receiving the second enabling signal;
a seventh switching unit, electrically connecting the source driver and the third sub-pixel, for conducting data signals of the second polarity to the third sub-pixel when receiving the third enabling signal; and
an eighth switching unit, electrically connecting the source driver and the eighth sub-pixel, for conducting data signals of the second polarity to the eighth sub-pixel when receiving the fourth enabling signal.

2. The liquid crystal display of claim 1, wherein the first sub-pixel and the fifth sub-pixel are red sub-pixels, the second sub-pixel and the sixth sub-pixel are green sub-pixels, the third sub-pixel and the seventh sub-pixel are blue sub-pixels, and the fourth sub-pixel and the eighth sub-pixel are white sub-pixels.

3. The liquid crystal display of claim 1, wherein the polarity of the data signal of the first frame and that of the second frame outputted consecutively by the source driver are opposite to each other.

4. A display device, comprising:
a source driver for outputting data signals;
a first pixel unit, comprising a first sub-pixel, a second sub-pixel, a third sub-pixel and a fourth sub-pixel, lining up along a row;
a second pixel unit, comprising a fifth sub-pixel, a sixth sub-pixel, a seventh sub-pixel and an eighth sub-pixel, lining up along the row;
a first switching unit, electrically connecting the source driver and the first sub-pixel, for conducting data signals of a first polarity to the first sub-pixel when receiving a first enabling signal;
a second switching unit, electrically connecting the source driver and the sixth sub-pixel, for conducting data signals of the first polarity to the sixth sub-pixel when receiving a second enabling signal;
a third switching unit, electrically connecting the source driver and the seventh sub-pixel, for conducting data signals of the first polarity to the seventh sub-pixel when receiving a third enabling signal;
a fourth switching unit, electrically connecting the source driver and the fourth sub-pixel, for conducting data signals of the first polarity to the fourth sub-pixel when receiving a fourth enabling signal;
a fifth switching unit, electrically connecting the source driver and the fifth sub-pixel, for conducting data signals of a second polarity to the fifth sub-pixel when receiving the first enabling signal;
a sixth switching unit, electrically connecting the source driver and the second sub-pixel, for conducting data signals of the second polarity to the second sub-pixel when receiving the second enabling signal;
a seventh switching unit, electrically connecting the source driver and the third sub-pixel, for conducting data signals of the second polarity to the third sub-pixel when receiving the third enabling signal; and
an eighth switching unit, electrically connecting the source driver and the eighth sub-pixel, for conducting data signals of the second polarity to the eighth sub-pixel when receiving the fourth enabling signal.

5. The display device of claim 4, wherein the first sub-pixel and the fifth sub-pixel are red sub-pixels, the second sub-pixel and the sixth sub-pixel are green sub-pixels, the third sub-pixel and the seventh sub-pixel are blue sub-pixels, and the fourth sub-pixel and the eighth sub-pixel are white sub-pixels.

6. The display device of claim 4, wherein the first polarity is opposite to the second polarity.

7. The display device of claim 6, wherein the polarity of the data signal of the first frame and that of the second frame outputted consecutively by the source driver are opposite to each other.

8. The display device of claim 4, wherein the display device is a liquid crystal display (LCD) or an organic light-emitting diode (OLED) display.

9. A method for driving a display device, the display device comprising:
a source driver for, outputting data signals;
a first pixel unit, comprising a first sub-pixel, a second sub-pixel, a third sub-pixel and a fourth sub-pixel, lining up along a row;
a second pixel unit, comprising a fifth sub-pixel, a sixth sub-pixel, a seventh sub-pixel and an eighth sub-pixel, lining up along the row;
a first switching unit, electrically connecting the source driver and the first sub-pixel;
a second switching unit, electrically connecting the source driver and the sixth sub-pixel;
a third switching unit, electrically connecting the source driver and the seventh sub-pixel;
a fourth switching unit, electrically connecting the source driver and the fourth sub-pixel;
a fifth switching unit, electrically connecting the source driver and the fifth sub-pixel;
a sixth switching unit, electrically connecting the source driver and the second sub-pixel;
a seventh switching unit, electrically connecting the source driver and the third sub-pixel;
an eighth switching unit, electrically connecting the source driver and the eighth sub-pixel;
wherein the method comprises:
when receiving a first enabling signal, the first switching unit conducting data signals of a first polarity to the first sub-pixel, and the fifth switching unit conducting data signals of a second polarity to the fifth sub-pixel;
when receiving a second enabling signal, the second switching unit conducting data signals of the first polarity to the sixth sub-pixel, and the sixth switching unit conducting data signals of the second polarity to the second sub-pixel;
when receiving a third enabling signal, the third switching unit conducting data signals of the first polarity to the seventh sub-pixel, and the seventh switching unit conducting data signals of the second polarity to the third sub-pixel;
when receiving a fourth enabling signal, the fourth switching unit conducting data signals of the first polarity to the fourth sub-pixel, and the eighth switching unit conducting data signals of the second polarity to the fourth sub-pixel.

10. The method of claim 9, wherein the first sub-pixel and the fifth sub-pixel are red sub-pixels, the second sub-pixel and the sixth sub-pixel are green sub-pixels, the third sub-pixel and the seventh sub-pixel are blue sub-pixels, and the fourth sub-pixel and the eighth sub-pixel are white sub-pixels.

11. The method of claim 9, wherein the first polarity is opposite to the second polarity.

12. The method of claim 11, wherein the polarity of the data signal of the first frame and that of the second frame outputted consecutively by the source driver are opposite to each other.

13. The method of claim 9, wherein the display device is a liquid crystal display (LCD) or an organic light emitting diode (OLED) display.
